(19) United States
(12) Patent Application Publication
(10) Pub. No.: US 2010/0213191 A1
(43) Pub. Date: Aug. 26, 2010

(54) Low Crystallinity Susceptor Films

(76) Inventors: Scott W. Middleton, Oshkosh, WI (US); Timothy H. Bohrer, Chicago, IL (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/709,628

(22) Filed: Feb. 22, 2010

Related U.S. Application Data
(60) Provisional application No. 61/208,379, filed on Feb. 23, 2009.
(60) Provisional application No. 61/273,090, filed on Jul. 30, 2009.
(60) Provisional application No. 61/236,925, filed on Aug. 26, 2009.

(51) Int. Cl. H05B 6/64

(52) U.S. Cl. 219/756; 219/759

(57) ABSTRACT

A microwave energy interactive structure comprises a polymer film having a crystallinity of less than about 50%, and a layer of microwave energy interactive material on the polymer film. The layer of microwave energy interactive material is operative for converting at least a portion of impinging microwave energy into thermal energy.

### CROSS-REFERENCE TO RELATED APPLICATIONS

This application claims the benefit of U.S. Provisional Application No. 61/208,379, filed Feb. 23, 2009, U.S. Provisional Application No. 61/273,090, filed Jul. 30, 2009, and U.S. Provisional Application No. 61/236,925, filed Aug. 26, 2009, each of which is incorporated by reference herein in its entirety.

### BACKGROUND

It is known to use a susceptor in microwave heating packages for enhancing the browning and/or crisping of an adjacent food item. A susceptor is a thin layer of microwave energy interactive material that tends to absorb at least a portion of impinging microwave energy and convert it to thermal energy (i.e., heat) through resistive losses in the layer of microwave energy interactive material. The remainder of the microwave energy is either reflected by or transmitted through the susceptor.

The layer of microwave energy interactive material (i.e., susceptor) is typically supported on a polymer film to define a susceptor film. In most conventional susceptor films, the polymer film comprises biaxially oriented, heat set polyethylene terephthalate. The susceptor film is typically joined (e.g., laminated) to a support layer, for example, paper or paperboard, using an adhesive or otherwise, to impart dimensional stability to the susceptor film and to protect the layer of metal from being damaged. The resulting structure may be referred to as a “susceptor structure”.

In a typical conventional susceptor film, the susceptor comprises aluminum, generally less than about 500 angstroms in thickness, for example, from about 60 to about 100 angstroms in thickness, and having an optical density of from about 0.15 to about 0.35, for example, about 0.17 to about 0.28, and the polymer film comprises a biaxially oriented, heat set film, for example, biaxially oriented film produced from polyethylene terephthalate (PET). Typically, such films are “highly oriented”, that is, the degree of stretch during the orienting process is from about 3.5:1 to about 4:1 in the machine direction (MD) and from about 3.5:1 to about 4:1 in the cross-machine direction (CD). Such susceptor structures are typically “self-limiting”, that is, the susceptor structure is subject to damage or degradation (i.e., crazing or cracking) upon reaching a certain temperature, thereby limiting the ability of the susceptor to generate heat. While not wishing to be bound by theory, it is believed that the heat of the susceptor releases some of the residual shrink forces in the highly oriented film, and that when the shrink forces exceed the ability of the laminating adhesive to maintain the film in its original configuration, the polymer film crazes (i.e., cracks), thereby forming discontinuities in the susceptor that interrupt the flow of electric current in the metal layer. As the crazing progresses and the cracks intersect one another, the network of intersecting lines subdivides the plane of the susceptor into progressively smaller conductive islands. As a result, the overall reflectance of the susceptor decreases, the overall transmission of the susceptor increases, and the amount of energy converted by the susceptor into sensible heat decreases.

When this self-limiting behavior occurs prematurely (i.e., too early in the heating cycle), the susceptor may not be able to generate the necessary amount of heat for a particular food heating application. In contrast, in some instances, this self-limiting behavior may be advantageous where runaway (i.e., uncontrolled) heating of the susceptor might otherwise cause excessive charring or scorching of the adjacent food item and/or any supporting structures or substrates, for example, paper or paperboard. Thus, for each application, the need for sufficient heating must be balanced with the desire to prevent undesirable overheating. Unfortunately, with a conventional highly oriented PET susceptor, the temperature at which crazing occurs can only be slightly controlled, for example, by modifying the thickness of the metal layer, the type and amount of adhesive, and the uniformity of the adhesive application.

Other polymers have been proposed as alternatives to highly oriented PET, such as polyethylene naphthalate and certain copolyesters such as polycyclohexylene-dimethylene terephthalate (PCDMT), which have inherently higher melting points. These materials, however, are difficult to process and more expensive than PET, and despite being disclosed in a variety of references, do not appear to have been commercialized. Further, some may pose safety hazards under certain heating conditions. For example, U.S. Pat. No. 5,527,413 discloses that PCDMT becomes so hot that it can burn or char the paper in the susceptor structure or burn food items in contact with the susceptor.

Thus, there is a need for a susceptor structure that is capable of achieving a greater heat flux and/or higher temperature than a conventional susceptor structure formed from a highly oriented film, thereby permitting better browning and/or crisping of a food item without the danger of excessive charring. There is also a need for a susceptor structure formed from a polymer film that is relatively easy to handle during manufacture of the susceptor structure.

### SUMMARY

This disclosure is directed generally to a polymer film for use in a susceptor film, a method of making such a polymer film, and a susceptor film including the polymer film. The susceptor may be joined to a support layer to form a susceptor structure. The susceptor film and/or susceptor structure may be used to form countless microwave energy interactive structures, microwave heating packages, or other microwave energy interactive constructs.

In one aspect, the polymer film may have a crystallinity of less than about 50% prior to heating in a microwave oven. In some embodiments, the crystallinity may be less than 25%, less than 10%, or less than 7%, for example, about 5%. In another aspect, the polymer film may generally be unoriented (i.e., non-oriented). Unoriented polymer films are films that are not subjected to stretching in either or both the machine and cross directions at temperatures below the melting point of the polymer. In some cases, polymer films are quenched rapidly when formed, which results in a low crystallinity, for example, less than about 25%, which may generally be attributed to the melt orientation associated with drawing down the melt to the desired final film thickness. It has been found that polymer films having a relatively low crystallinity and/or that are at least substantially unoriented may be used in susceptor films and susceptor structures to achieve a greater heat flux and/or higher temperature than a conventional susceptor structure comprising a highly oriented polymer film.

In one exemplary embodiment, the polymer film may comprise amorphous polyethylene terephthalate (APET) or amorphous nylon.

If desired, one or more additives (i.e., polymers) may be incorporated into the polymer film to enhance the strength and/or processability of the polymer film. Additionally or alternatively, the strength and/or processability of the polymer film may be enhanced by using a multilayer polymer film, where one or more of such layers provide the desired level of robustness for the polymer film. Accordingly, the multilayer film may feature enhanced tear strength, toughness, and improved dimensional tolerance so that the film may be processed (e.g., metallized, chemically etched, laminated, and/or printed) and converted into various susceptor structures and/or packages using high speed converting operations.

If desired, additional functional characteristics can be imparted to the multilayer film by selecting polymers having the desired attributes. For example, the multilayer film may have barrier characteristics that may render the polymer film suitable for numerous applications, for example, for packages for refrigerated microwavable food items that require an extended shelf life.

In another aspect, the polymer film may have a temperature resistance that can be modified through the use of additives blended with the polymer.

Other features, aspects, and embodiments of the invention will be apparent from the following description.

### DESCRIPTION

Although some attempts to understand the self-limiting behavior of susceptors have been made, the relationship between the shrink characteristics of oriented films used for microwave susceptor films and the resulting susceptor performance has generally not been explored or appreciated.

Accordingly, this disclosure is directed to various susceptor films that are capable of attaining higher temperatures than conventional susceptor films, while providing the desired level of self-limiting behavior. The susceptor films generally include a polymer film having a crystallinity of less than about 50% prior to heating in a microwave oven.

In one aspect, the susceptor film may include an unoriented (i.e., non-oriented) polymer film. Unoriented polymer films can be quenched rapidly, which results in a low crystallinity, for example, less than about 25%, which may generally be attributed to the melt orientation associated with drawing down the melt to the desired final film thickness. In contrast, highly oriented films of the type used in conventional susceptor films and structures have high levels of orientation or strain induced crystallinity and possess significant amounts of residual shrink forces.

Any suitable unoriented polymer film may be used to form a susceptor film in accordance with the disclosure. In one embodiment, the substrate may comprise an unoriented, amorphous PET (APET) film having a crystallinity of less than about 25%, for example, less than about 10%, for example, less than about 7%, for example, about 5%. One example of an APET film that may be suitable is available from Pure-Stat Technologies, Inc. (Lewiston, Me.). However, other suitable APET films and/or other polymer films may be used.

The present inventors have discovered that susceptor films including an unoriented polymer film may tend to resist crazing to a greater extent than conventional, highly oriented films. While not wishing to be bound by theory, it is believed that high shrink forces may have a significant role in the onset and propagation of crazing of susceptor structures. Since unoriented films exhibit much lower heat induced dimensional shrinkage forces than highly oriented films, unoriented polymer films may tend to resist crazing more than highly oriented polymer films. Thus, an unoriented polymer film with inherently low shrinkage forces, for example, APET, may tend to resist crazing to a greater extent than a conventional, highly oriented film with inherently high shrink forces, for example, a highly oriented PET.

Alternatively or additionally, and while not wishing to be bound by theory, it also is believed that the crystallinity of the unoriented polymer film increases during the heating cycle, thereby rendering the polymer more resistant to heat, and therefore, more heat stable. As a result, the stability of the susceptor film may increase during the heating cycle.

If desired, the kinetics of crystallization of the polymer film may be manipulated to achieve the desired level of crystallinity at various points in the heating cycle, with time, temperature, and the use of nucleating agents being variables that may be adjusted as needed to attain the desired susceptor film performance. For example, since part of the mechanism for crazing in highly oriented PET susceptor films is believed to be the different dimensional changes in the film, metal layer, and adhesive layer during the heating cycle, it is believed that one or more nucleating agents may be used to attain certain film properties at different points in the heating cycle that better accommodate the dimensional changes of the metal layer and adhesive. As a result, the interlayer stresses, and therefore, any undesirable crazing, may be minimized.

Since different food products require different heating cycles for optimum preparation, it is anticipated that the additional degrees of freedom associated with controlling initial crystallinity levels and the kinetics of further crystallinity increases during heating will permit expanded customization capabilities, which may further enhance the utility and uniqueness of the susceptor films described herein.

It is also contemplated that in some instances, the susceptor film may be intended to be used more than once. In such instances, the crystallinity of the polymer film may be higher upon the second use and any subsequent use.

The polymer film may be formed in any suitable manner. In one example, the polymer film substrate may be a water quenched film, a cast film, or any other type of polymer film that is formed using a rapid quenching process. When such films do not undergo a conventional post-extrusion orientation process, it will be appreciated that, in some instances, the film may be difficult to handle and/or convert into a susceptor structure. Thus, it is contemplated that the film may be subject to a minimal orienting process to orient (i.e., stretch) the film slightly (e.g., up to about 20%, for example, from about 5% to about 20%) to improve processability of the film. Since such orienting is relatively minor as compared with standard highly oriented films that are stretched about 250-300% in each direction, such slightly oriented films shall be considered herein to be “substantially unoriented”. If desired, the crystallinity of unoriented or substantially unoriented films can be controllably increased through post-extrusion heat treatment or conditioning. The utilization of the crystallization kinetic modifying additives described above is also an option in this case.

Additionally or alternatively, additives may be incorporated into the film to modify its properties to facilitate processing or to provide more robust microwave heating performance. As an example, a strength enhancing additive (e.g., a polymer) may be used to make more robust an otherwise somewhat fragile low gauge cast APET film. Examples of additives that may be suitable include an ethylene methyl acrylate copolymer, an ethylene-octene copolymer, or any other suitable polymer or material that improves the strength and/or processability of the polymer film. Other additives providing different functions or benefits may also be used. Any of such additives may be added in any suitable amount, for example, up to about 15% by weight of the polymer film, up to about 10% by weight of the polymer film, up to about 5% by weight of the polymer film, or in any other suitable amount. In other examples, the additives may be used in an amount of from about 1% to about 10%, from about 2% to about 8%, from 3% to about 5% by weight of the polymer film, or in any suitable amount or range of amounts.

Alternatively or additionally, the APET may be used to form a multilayer film including at least two distinct layers, each of which may comprise one or more polymers and, optionally, one or more additives. The layers may be coextruded or may be formed separately and joined to one another using an adhesive, a tie layer, thermal bonding, or using any other suitable technique. Other suitable techniques may include extrusion coating and coextrusion coating.

Each layer of the multilayer film may be a rapidly quenched film, i.e., a film formed under conditions that provide very fast freezing of the polymer melt after it has exited the opening of the extrusion die. This rapid freezing and further lowering of the temperature of the solidified polymer film minimizes the development of crystalline micro or macro structures. It is believed that when films with low crystallinity are used to form a susceptor film, the susceptor film is capable of achieving higher temperatures and heat flux during microwave heating, as compared with conventional susceptors made from biaxially oriented polyethylene terephthalate (BOPET).

If desired, additional functional characteristics can be imparted to the multilayer film by selecting polymers having the desired attributes. For example, ethylene vinyl alcohol (EVOH) may be used to impart oxygen barrier properties. Polypropylene (PP) may be used to impart water vapor barrier properties. Such properties may render the film useful for controlled or modified atmosphere packaging, and in particular, for chilled or shelf stable foods, where higher oxygen and moisture barriers are typically required than for frozen foods. Numerous other possibilities are contemplated.

Numerous multilayer films are contemplated by the disclosure. By way of illustration and not limitation, some exemplary structures include: (a) APET/olefin; (b) APET/tie layer/olefin; (c) APET/tie layer/olefin/tie layer/APET; (d) APET/tie layer/PP/tie layer/APET; (e) APET/tie layer/PP/tie layer/amorphous nylon 6 or nylon 6,6; (f) APET/tie layer/APET; (g) APET/tie layer/EVOH/tie layer/APET; (h) APET/tie layer; (i) APET/tie layer/regrind of all layers/tie layer/EVOH/tie layer/APET; (j) APET/tie layer/EVOH/tie layer/amorphous nylon 6 or nylon 6,6; (k) APET/tie layer/olefin/tie layer/EVOH/tie layer/APET; and (l) APET/tie layer/olefin/tie layer/EVOH/tie layer/nylon 6,6.

In examples a-c and k-l and in any other multilayer film contemplated by this disclosure, the olefin layer may comprise any suitable polyolefin, for example, low density polyethylene (LDPE), linear low density polyethylene (LLDPE), medium density polyethylene (MDPE), high density polyethylene (HDPE), polypropylene (PP), copolymers of any of such polymers, and/or metallocene catalyzed versions of these polymers or copolymers.

In example i and in any other multilayer film contemplated by the disclosure, the regrind layer may include the film edge scrap and any other recyclable material, according to conventional practice. Any of the various other examples (examples a-h or j-l) or other films contemplated by this disclosure may contain such a regrind layer. In some cases, regrind layers may require a tie layer to bond them satisfactorily to the adjacent film layers.

In examples b-j, and in any other multilayer film contemplated by this disclosure, the tie layer may comprise any suitable material that provides the desired level of adhesion between the adjacent layers. In some exemplary embodiments, the tie layer may comprise Bynel® from DuPont, Plexar® from Equistar, a LyondellBasell company, or Exxlor™ from Exxon. The precise selection of the tie layer depends on the adjacent polymers it is intended to join and rheological properties that ensure even distribution of layers in the coextrusion process. For example, DuPont Bynel 21E781 is part of the Bynel 2100 Series of anhydride modified ethylene acrylate resins that are most often used to adhere to PET, nylon, EVOH, polyethylene (PE), PP, and ethylene copolymers. Plexar® PX1007 is one of a class of ethylene vinyl acetate copolymers that can be used to bond a similar range of materials as the Bynel resin mentioned previously. Exxlor® grades may be used to enhance the impact performance of various nylon polymers. In addition, the tie layers and other resins may be selected for their prior sanctioned use in high temperature films for applications such as retort pouches, where minimal resin extractables into food are allowed.

It is contemplated that either amorphous nylon 6 or nylon 6,6 could be substituted for APET in any of the above multilayer film structures or any other structure within the scope of the disclosure. Countless other structures are contemplated.

Numerous techniques may be used to form a multilayer film. While film casting is a commonly used rapid quench film production technique, adaptations of the air-cooled blown film process may also create quench rates suitable for the creation of the multilayer films of this disclosure. The use of chilled air applied to the outside of the blown film “bubble” can increase the quench rate compared to the use of room temperature air directed only on the exterior surface of the bubble. Additionally, the use of chilled air exchange for internal bubble cooling can boost output rates. Higher quench rates can be achieved through the use of water cooled mandrels that contact the interior of the bubble, but this process is relatively inflexible in the width of film that can be produced, as the higher quench rates are only achieved from intimate contact between the polymer bubble and the mandrel, and different mandrels are required to produce different film widths.

Another approach for the tubular film blowing process is the tubular water quench process (TWQ). TWQ entails the direct contact of cooling water with the exterior of the polymer bubble, which results in extremely high heat transfer rates and very rapid quenching of the extruded polymer film. Some TWQ processes combine direct water contact with the exterior of the bubble with an internal mandrel for support and further cooling. Another TWQ process may solely utilize direct water contact on the external surface of the bubble, sometimes supplemented with chilled air exchange in the interior of the bubble. In some circumstances, the latter TWQ process may be more advantageous to use because equipment without internal mandrels is less costly to build and operate and provides more flexibility in film width changes. Such TWQ extrusion lines are available, for example, from Brampton Engineering of Canada under the trade name AquaFrost® systems. However, numerous other processes and systems may be used.

The basis weight and/or caliper of the polymer film, whether single layer or multilayer, may vary for each application. In some embodiments, the film may be from about 12 to about 50 microns thick, for example, from about 15 to about 35 microns thick, for example, about 20 microns thick. However, other calipers are contemplated.

Following film manufacture, a layer of microwave energy interactive material (i.e., a susceptor or microwave susceptible coating) may be deposited on one or both sides of the polymer film to form a susceptor film. The microwave energy interactive material may be an electroconductive or semiconductive material, for example, a vacuum deposited metal or metal alloy, or a metallic ink, an organic ink, an inorganic ink, a metallic paste, an organic paste, an inorganic paste, or any combination thereof. Examples of metals and metal alloys that may be suitable include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide, for example, oxides of aluminum, iron, and tin, optionally used in conjunction with an electrically conductive material. Another metal oxide that may be suitable is indium tin oxide (ITO). ITO has a more uniform crystal structure and, therefore, is clear at most coating thicknesses.

Alternatively still, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

In other embodiments, the microwave energy interactive material may be carbon-based, for example, as disclosed in U.S. Pat. Nos. 4,943,456, 5,002,826, 5,118,747, and 5,410,135.

In still other embodiments, the microwave energy interactive material may interact with the magnetic portion of the electromagnetic energy in the microwave oven. Correctly chosen materials of this type can self-limit based on the loss of interaction when the Curie temperature of the material is reached. An example of such an interactive coating is described in U.S. Pat. No. 4,283,427.

The susceptor film may then be laminated or otherwise joined to another material to produce a susceptor structure or package. In one example, the susceptor film may be laminated to paper or paperboard to make a susceptor structure having a higher thermal flux output than conventional paper or paperboard based susceptor structures. The paper may have a basis weight of from about 15 to about 60 lb/ream (lb/3000 sq. ft.), for example, from about 20 to about 40 lb/ream, for example, about 25 lb/ream. The paperboard may have a basis weight of from about 60 to about 330 lb/ream, for example, from about 80 to about 140 lb/ream. The paperboard generally may have a thickness of from about 6 to about 30 mils, for example, from about 12 to about 28 mils. In one particular example, the paperboard has a thickness of about 14 mils (0.014 inches). Any suitable paperboard may be used, for example, a solid bleached sulfate board, for example, Fortress® board, commercially available from International Paper Company, Memphis, Tenn., or solid unbleached sulfate board, such as SUS® board, commercially available from Graphic Packaging International.

If desired, the polymer film may undergo one or more treatments to modify the surface prior to depositing the microwave energy interactive material onto the polymer film. By way of example, and not limitation, the polymer film may undergo a plasma treatment to modify the roughness of the surface of the polymer film. While not wishing to be bound by theory, it is believed that such surface treatments may provide a more uniform surface for receiving the microwave energy interactive material, which in turn, may increase the heat flux and maximum temperature of the resulting susceptor structure. Such treatments are discussed in U.S. patent application Ser. No. 12/709,578, filed Feb. 22, 2010, which is incorporated by reference herein in its entirety.

Also, if desired, the susceptor film may be used in conjunction with other microwave energy interactive elements and/or structures. Structures including multiple susceptor layers are also contemplated. It will be appreciated that the use of the present susceptor film and/or structure with such elements and/or structures may provide enhanced results as compared with a conventional susceptor.

By way of example, the susceptor film may be used with a foil or high optical density evaporated material having a thickness sufficient to reflect a substantial portion of impinging microwave energy. Such elements typically are formed from a conductive, reflective metal or metal alloy, for example, aluminum, copper, or stainless steel, in the form of a solid “patch” generally having a thickness of from about 0.000285 inches to about 0.005 inches, for example, from about 0.0003 inches to about 0.003 inches. Other such elements may have a thickness of from about 0.00035 inches to about 0.002 inches, for example, 0.0016 inches.

In some cases, microwave energy reflecting (or reflective) elements may be used as shielding elements where the food item is prone to scorching or drying out during heating. In other cases, smaller microwave energy reflecting elements may be used to diffuse or lessen the intensity of microwave energy. One example of a material utilizing such microwave energy reflecting elements is commercially available from Graphic Packaging International, Inc. (Marietta, Ga.) under the trade name MicroRite® packaging material. In other examples, a plurality of microwave energy reflecting elements may be arranged to form a microwave energy distributing element to direct microwave energy to specific areas of the food item. If desired, the loops may be of a length that causes microwave energy to resonate, thereby enhancing the distribution effect. Microwave energy distributing elements are described in U.S. Pat. Nos. 6,204,492, 6,433,322, 6,552,315, and 6,677,563, each of which is incorporated by reference in its entirety.

In still another example, the susceptor film and/or structure may be used with or may be used to form a microwave energy interactive insulating material. Examples of such materials are provided in U.S. Pat. No. 7,019,271, U.S. Pat. No. 7,351,942, and U.S. Patent Application Publication No. 2008/0078759 A1, published Apr. 3, 2008, each of which is incorporated by reference herein in its entirety.

If desired, any of the numerous microwave energy interactive elements described herein or contemplated hereby may be substantially continuous, that is, without substantial breaks or interruptions, or may be discontinuous, for example, by including one or more breaks or apertures that transmit microwave energy. The breaks or apertures may extend through the entire structure, or only through one or more layers. The number, shape, size, and positioning of such breaks or apertures may vary for a particular application depending on the type of construct being formed, the food item to be heated therein or thereon, the desired degree of heating, browning, and/or crisping, whether direct exposure to microwave energy is needed or desired to attain uniform heating of the food item, the need for regulating the change in temperature of the food item through direct heating, and whether and to what extent there is a need for venting.

By way of illustration, a microwave energy interactive element may include one or more transparent areas to effect dielectric heating of the food item. However, where the microwave energy interactive element comprises a susceptor, such apertures decrease the total microwave energy interactive area, and therefore, decrease the amount of microwave energy interactive material available for heating, browning, and/or crisping the surface of the food item. Thus, the relative amounts of microwave energy interactive areas and microwave energy transparent areas must be balanced to attain the desired overall heating characteristics for the particular food item.

In some embodiments, one or more portions of the susceptor may be designed to be microwave energy inactive to ensure that the microwave energy is focused efficiently on the areas to be heated, browned, and/or crisped, rather than being lost to portions of the food item not intended to be browned and/or crisped or to the heating environment.

In other embodiments, it may be beneficial to create one or more discontinuities or inactive regions to prevent overheating or charring of the food item and/or the construct including the susceptor. By way of example, the susceptor may incorporate one or more “fuse” elements that limit the propagation of cracks in the susceptor structure, and thereby control overheating, in areas of the susceptor structure where heat transfer to the food is low and the susceptor might tend to become too hot. The size and shape of the fuses may be varied as needed. Examples of susceptors including such fuses are provided, for example, in U.S. Pat. No. 5,412,187, U.S. Pat. No. 5,530,231, U.S. Patent Application Publication No. US 2008/0035634A1, published Feb. 14, 2008, and PCT Application Publication No. WO 2007/127371, published Nov. 8, 2007, each of which is incorporated by reference herein in its entirety.

In the case of a susceptor, any of such discontinuities or apertures may comprise a physical aperture or void in one or more layers or materials used to form the structure or construct, or may be a non-physical “aperture”. A non-physical aperture is a microwave energy transparent area that allows microwave energy to pass through the structure without an actual void or hole cut through the structure. Such areas may be formed by simply not applying microwave energy interactive material to the particular area, by removing microwave energy interactive material from the particular area, or by mechanically deactivating the particular area (rendering the area electrically discontinuous). Alternatively, the areas may be formed by chemically deactivating the microwave energy interactive material in the particular area, thereby transforming the microwave energy interactive material in the area into a substance that is transparent to microwave energy (i.e., microwave energy inactive). While both physical and non-physical apertures allow the food item to be heated directly by the microwave energy, a physical aperture also provides a venting function to allow steam or other vapors or liquids released from the food item to be carried away from the food item.

The present invention may be understood further in view of the following examples, which are not intended to be limiting in any manner. All of the information provided represents approximate values, unless otherwise specified.

### Example 1

A calorimetry test was conducted to determine the thermal flux produced by and maximum temperature reached by various susceptor structures.

Various polymer films were used to form the susceptor structures, as set forth in Table 1. The polymer films included DuPont Mylar® 800C BOPET (DuPont Teijin Films™, Hopewell, Va.), Pure-Stat APET (Pure-Stat Technologies, Inc., Lewiston, Me.), DuPont HS2 PET (DuPont Teijin Films™, Hopewell, Va.), and Toray Lumirror® F65 PET (Toray Films Europe). All of the films except the Pure-Stat APET film were highly oriented, as evidenced by the refractive index data (compare the refractive index of samples 1-1 and 1-6 with the refractive index of samples 1-3 and 1-4). All these films were without added colorants or pigmentation, and thus were clear.

Each susceptor structure was made by joining a susceptor film to a paperboard support layer using from about 1.5 to about 2.0 lb/ream of one of the following adhesives: Royal 20469 (Royal Adhesives & Sealants, South Bend, Ind.), Royal 20123 (Royal Adhesives & Sealants, South Bend, Ind.), or Henkel 5T-5380M5 (Henkel Adhesives, Elgin, Ill.). However, other suitable adhesives may be used.

The calorimetry data was collected using a FISO MWS Microwave Work Station fiber optic temperature sensing device (FISO, Quebec, Canada) with eight (8) channels mounted onto a Panasonic 1300 watt consumer microwave oven model NN-S760WA. A sample having a diameter of about 5 in. was positioned between two circular Pyrex® plates, each having a thickness of about 0.25 in. and a diameter of about 5 in. An about 250 g water load in a plastic bowl resting on an about 1 in. thick expanded polystyrene insulating sheet was placed above the plates (so that radiant heat from the water did not affect the plates). The bottom plate was raised about 1 in. above the glass turntable using three substantially triangular ceramic stands. Thermo-optic probes were affixed to the top surface of the top plate to measure the surface temperature of the plate. After heating the sample at full power for about 5 minutes in an about 1300 W microwave oven, the average maximum temperature rise in degrees C. of the top plate surface was recorded. (Finite element analysis modeling of the calorimetry test method has shown that the average maximum temperature rise is proportional to the thermal flux generated by the susceptor structure.) The conductivity σ (mmho/sq) of each sample was measured using a Delcom 717 conductance monitor (Delcom Instruments, Inc., Prescott, Wis.) prior to conducting the calorimetry test, with five data points being collected and averaged. The results are presented in Table 1.

In general, structures 1-3 and 1-4 provided the most heating power and the least amount of crazing, while structure 1-1 exhibited a lower heating power than structures 1-3 and 1-4 and the greatest amount of crazing. Structure 1-6 had less crazing than the control structure 1-1 and provided a moderate heating power.

Notably, structure 1-5, which had already been heated once, exhibited a greater power output than structure 1-1. Although no visible crazing was observed, the sample still exhibited some degree of self-limiting behavior (as evidenced by ΔTmax). While not wishing to be bound by theory, it is believed that this self-limiting behavior is at least partially the result of a change in density of the polymer film during the microwave heating cycle. Specifically, it is known that the density of a polymer film may decrease as the polymer film heats. However, as the polymer film heats, there is also an increase in crystallinity and an accompanying increase in density. It is believed that the magnitude of this increase in density exceeds the magnitude of the initial density decrease, such that there is an overall increase in density during the heating cycle. It is further believed that this increase in density may cause disruptions or microcrazing in the susceptor structure that create electrical discontinuities on an atomic scale.

TABLE 1

| | | | | Degree of | Refractive | | | | | | |
|---|---|---|---|---|---|---|---|---|---|---|---|
| | | | % | post- | index | Degree | | | | | |
| | Polymer film | Board | Crystallinity | extrusion | n_{z} (MD) | of heat | Power | ΔT max | σ, before | σ, after | Visible |
| Structure | (0.5 mil) | (pt) | (initial) | orientation | n_{y} (CD) | setting | (W/m²) | (° C.) | (mmho/sq.) | (mmho/sq.) | crazing |
| 1-1 | DuPont Mylar | 18 | 53 | High | 1.6644 | Medium | 9,912 | 142.9 ± 4.5 | 20 | 0 | Yes |
| | 800 C. PET | | | | 1.6488 | | | | | | |
| 1-2 | DuPont Mylar | 18 | — | High | — | Medium | 7,339 | 111.0 ± 18 | 0 | 0 | Yes |
| | 800 C. PET, | | | | | | | | | | |
| | second heating | | | | | | | | | | |
| 1-3 | Pure-Stat | 12 | 5 | None | 1.5734 | None | 11,670 | 164.7 | 13 ± 1 | 1 ± 0 | No |
| | APET, | | | | 1.5735 | | | | | | |
| | metallized on | | | | | | | | | | |
| | first side | | | | | | | | | | |
| 1-4 | Pure-Stat | 12 | 5 | None | 1.5733 | None | 11,839 | 166.8 | 14 ± 1 | 1 ± 0 | No |
| | APET, | | | | 1.5737 | | | | | | |
| | metallized on | | | | | | | | | | |
| | second side | | | | | | | | | | |
| 1-5 | Pure-Stat | 12 | 5 | None | — | None | 10,404 | 149.0 | 1 | 0 | No |
| | APET, second | | | | | | | | | | |
| | heating on first | | | | | | | | | | |
| | side | | | | | | | | | | |
| 1-6 | DuPont HS2 | 14 | 55 | High | 1.6587 | High | 10,646 | 152 | 5 | 0 | Yes |
| | | | | | 1.6568 | | | | | | |
| 1-7 | Toray F65 | 12 | 55 | High | — | High | 10,452 | 149.6 ± 3.8 | 8 | 0 | Yes |

### Example 2

The microwave reflection, absorption, and transmission (RAT) properties of a conventional susceptor structure (structure 1-1) were compared with an experimental susceptor structure (structure 1-3) using the calorimetry test described in Example 1 with various heating times. Further, a new parameter, craze perimeter divided by field area (P/A, mm/mm²), was determined for some heating times of structure 1-1 using image analysis to examine the respective samples after heating. A merit factor was also calculated at each heating time, where:

Merit Factor=Absorbance (A)/(1−Reflectance (R)).

The results are presented in Tables 2 and 3. Since little or no crazing was observed for structure 1-3, no P/A data is presented in Table 3.

Notably, at longer heating times, structure 1-3 provided greater heating than structure 1-1. Susceptor structures with larger merit factors generally exhibit greater food surface browning and crisping because they limit the amount of direct microwave heating of the food while maximizing the susceptor absorbance. Therefore, as a practical matter, a structure using a low crystallinity polymer film may be able to advantageously provide a greater level of surface browning and/or crisping while minimizing dielectric heating of the food item.

TABLE 2
Structure 1-1

| Time of | | | | | | |
|---|---|---|---|---|---|---|
| Heating | | | | Merit Factor | Delta T | P/A |
| (sec) | R | A | T | A/(1 − R) | Max (° C.) | (mm/mm²) |
| 1 | 0.43 | 0.47 | 0.10 | 0.82 | — | — |
| 2 | 0.42 | 0.47 | 0.11 | 0.81 | 0 | — |
| 5 | 0.43 | 0.46 | 0.10 | 0.81 | — | — |
| 10 | 0.41 | 0.48 | 0.12 | 0.81 | 5 | — |
| 20 | 0.33 | 0.46 | 0.21 | 0.69 | 16 | — |
| 40 | 0.28 | 0.44 | 0.28 | 0.61 | 32 | 1.32 |
| 60 | 0.26 | 0.37 | 0.37 | 0.50 | 51 | 1.00 |
| 80 | n/a | n/a | n/a | n/a | 64 | — |
| 100 | 0.27 | 0.38 | 0.35 | 0.52 | 67 | — |
| 140 | 0.20 | 0.23 | 0.57 | 0.29 | 91 | 1.03 |
| 160 | 0.24 | 0.28 | 0.48 | 0.37 | 93 | — |
| 180 | 0.18 | 0.19 | 0.63 | 0.23 | 111 | — |
| 180 | 0.18 | 0.18 | 0.64 | 0.22 | 110 | 1.97 |
| 200 | 0.18 | 0.20 | 0.62 | 0.24 | 120 | — |
| 220 | 0.22 | 0.21 | 0.57 | 0.27 | 118 | — |
| 240 | 0.20 | 0.24 | 0.56 | 0.30 | 114 | — |
| 260 | 0.17 | 0.16 | 0.67 | 0.19 | 127 | 1.64 |
| 280 | 0.16 | 0.15 | 0.69 | 0.18 | 133 | — |
| 300 | n/a | n/a | n/a | n/a | 141 | 2.77 |

TABLE 3
Structure 1-3

| Time of | | | | | |
|---|---|---|---|---|---|
| Heating | | | | Merit Factor | Delta T Max |
| (sec) | R | A | T | A/(1 − R) | (° C.) |
| 0 | 0.42 | 0.47 | 0.11 | 0.81 | 0 |
| 5 | 0.43 | 0.46 | 0.11 | 0.81 | 1.0 |
| 10 | 0.41 | 0.46 | 0.13 | 0.78 | 5.2 |
| 20 | 0.42 | 0.46 | 0.11 | 0.79 | 17.6 |
| 40 | 0.40 | 0.43 | 0.17 | 0.72 | 34.4 |
| 80 | 0.40 | 0.47 | 0.13 | 0.78 | 64.9 |
| 160 | 0.30 | 0.49 | 0.20 | 0.70 | 120.7 |
| 320 | 0.12 | 0.48 | 0.40 | 0.55 | 178.8 |

### Example 3

Image analysis was used to determine the extent of browning of a food item using various susceptor structures. In each example, a Stouffer's flatbread melt was heated on the susceptor structure for about 2.5 minutes in a 1000 W microwave oven. When the heating cycle was complete, the food item was inverted and the side of the food item heated adjacent to the susceptor was photographed. Adobe Photoshop was used to evaluate the images. To do so, various RGB (red/green/blue) setpoints were selected to correspond to various shades of brown, with higher setpoints corresponding to lighter shades. At each RGB setpoint, the number of pixels having that shade was counted. A tolerance of 20 was used. The results are presented in Table 4. Although all of the structures provided some degree of browning and/or crisping, structure 1-3 provided the greatest degree of browning and crisping without burning the food item or susceptor structure.

TABLE 4

| | | No. of | No. of | No. of |
|---|---|---|---|---|
| | | pixels | pixels | pixels |
| Test | Structure | RGB = 33 | RGB = 85 | RGB = 109 |
| 4-1 | Structure 1-1 | 984 | 3619 | 6330 |
| | (0.5 mil DuPont 800C | | | |
| | susceptor film joined | | | |
| | to 18 pt paperboard) | | | |
| 4-2 | Structure 1-3 (sample 1) | 8591 | 10976 | 1764 |
| | (0.5 mil Pure-Stat APET | | RGB = 82 | |
| | susceptor film joined | | | |
| | to 12 pt paperboard) | | | |
| 4-3 | Structure 1-3 (sample 2) | 9023 | 7099 | 1907 |
| | (0.5 mil Pure-Stat APET | | RGB = 82 | |
| | susceptor film joined | | | |
| | to 12 pt paperboard) | | | |

### Example 4

Various films and susceptor structures were prepared for evaluation. Two film producers were used to prepare APET films: SML Maschinengesellschaft mbH (Leming, Austria) (“SML”) (sample 5-3) and Pure-Stat Technologies, Inc. (Lewiston, Me.) (“Pure-Stat”) (samples 5-4 through 5-15). Additionally, Dartek® N201 nylon 6,6 (Liqui-box Canada, Whitby, Ontario, Canada) was evaluated (sample 5-2). Mylar® 800 biaxially oriented PET (DuPont Teijan™ Films, Hopewell, Va.) (sample 5-1) was evaluated as a control material.

Various strength enhancing additives were also evaluated, including Optima™ TC 120 and Optima™ TC 220 ExCo (ethylene methyl acrylate copolymer resins, ExxonMobil Chemical), Sukano im F535 (ethylene methyl acrylate copolymer resin, Sukano Polymers Corporation, Duncan, S.C.), Engage™ 8401 (ethylene-octene copolymer, Dow Plastics), and Americhem 60461-CD1 (composition unknown) (Americhem Cuyahoga Falls, Ohio).

The process for forming the APET film used by Pure-Stat Technologies, Inc. was as follows. Traytuf® 9506 PET resin pellets (M&G Polymers USA, LLC, Houston, Tex.) were desiccant dried and conveyed to a cast film line extruder hopper. The additive pellets were metered into the extruder throat, combined with the dry PET pellets, melted, mixed, and extruded through a slot die to form a flat molten film. The molten film was cast onto a cooling drum, rapidly quenched into a largely amorphous solid state, and conveyed over rollers to a windup where the film was wound into a roll for further processing. The film was about 0.0008 inches or about 80 gauge in thickness. It will be noted that thicker or thinner films can be produced by varying the extruder output and cooling drum surface speed. The process used by SML Maschinengesellschaft mbH was similar.

DSC data was obtained for each film sample by heating the sample in a Perkin-Elmer differential scanning calorimeter (DSC-7) at 10° C./minute, with a nitrogen purge to prevent degradation. Values were measured for samples heated to 300° C. and cooled to 40° C. The results are presented in Table 5. It is important to note that the DSC data was taken from an initial heating of the test specimens. Therefore, the values reflect the impact of any post-extrusion orientation and the specific thermal heat history each specimen experienced due to processing and the impact on crystallinity of the specimen. The negative enthalpy change associated with crystallization is proportional to the amount of non-crystalline polymer present in the specimen. The positive enthalpy change associated with melting is a measure of the degree of crystallinity attained by the specimen during the DSC measurement. The more equal the absolute values of these enthalpy values the more amorphous the specimen. Therefore, the values confirm that the highly oriented film, sample 5-1, possessed very high levels of orientation and crystallinity and the cast APET films 5-3 through 5-15, films possessed low levels of crystallinity. The somewhat larger differences in enthalpy noted for samples 5-6 through 5-15 reflect the impact of the non-PET strengthening additives present, but still are indicative of low levels of crystallinity in these films

The apparent roughness of the surface (PEL) of each film was evaluated before and after treatment. Images of the surface of the film were acquired using atomic force microscopy (AFM) at 0 to 100 nm full scale. A gray level histogram was generated using a gray scale from 0 to 256 units full scale light to dark using an image analysis system developed by Integrated Paper Services (IPS), Appleton, Wis. A binary image was produced at a gray scale of 120, which is equivalent to a plane intersecting the Z direction of the AFM image at 120/256*100 nm=46.9 nm or 469 angstroms in height. The perimeter of the detected region was measured and normalized by the linear size of the image to form a dimensionless ratio, perimeter divided by edge length, or PEL, with greater PEL values indicating a rougher surface. In general, the PEL data indicate that lower PEL levels (smoother film surface) are associated higher calorimetry and browning results.

Shrink/expansion data was obtained for several representative film samples with a Perkin-Elmer DMA 7e by monitoring the changes in the sample length as a function of temperature. The instrument was used in the constant force, thermal mechanical analysis mode. Samples were heated from 40 to 230° C. at 2.5° C. per minute under a helium purge with a constant static force of 10 mN. An extension analysis measuring system was used with samples cut 3.2 mm wide, with 0.015 mm in thickness, and with gauge lengths of about 10 mm. An ice/water bath was used to aid with furnace temperature control. The results are presented as the temperature in degrees Celsius (° C.) when a 1% change in dimension occurred. For the control sample (sample 5-1), the temperature in ° C. at 1% MD shrink was 130 and 160 (two samples), and the temperature in ° C. at 1% CD Shrink was 170. The remaining samples tested (samples 5-6, 5-7, 5-8, 5-10, 5-12, and 5-14) exhibited no shrinking and instead expanded slightly due to the small tension applied to the samples in the test method. The release of residual stresses in the control sample (sample 5-1) overcame the tension of the test method to create the shrinkage noted above.

Peak load before break was measured according to TAPPI T-494 om-01. The values indicate that the strengthening additives in samples 5-6 through 5-15 were successful in increasing the robustness of the films. This was borne out in trials on commercial production equipment, where strengthening additive modified films processed without difficulties, while unmodified films of the type represented by samples 5-3 through 5-5 were more fragile in converting operations, and required adjustments to normal process parameters such as tension, and were converted less efficiently.

The haze of each polymer film was measured according to ASTM D1003 using a BYK Gardener Haze-Gard plus 4725 haze meter. In all cases, the incorporation of strengthening additives increased the haze of the films. In some instances, the most preferable additives may be those which exhibit lower levels of haze while providing the desired increase in strength for processing, and result in beneficially increased heating performance when made into susceptor films and structures.

The films were then metallized with aluminum and joined to 14 pt (0.014 inches thick) Fortress® board (International Paper Company, Memphis, Tenn.) using a substantially continuous layer of from about 1 to about 2 lb/ream (as needed) Royal Hydra Fast-en® 20123 adhesive (Royal Adhesives, South Bend, Ind.) to form a susceptor structure.

Each susceptor structure was then evaluated using the calorimetry test described in Example 1. The results are presented in Table 5, where AAT is the difference between the rise in temperature for the sample and the rise in temperature for the control sample (structure 5-1, standard biaxially oriented, heat set PET film).

Additionally, each structure was evaluated using the pizza browning test described in Example 1, except that only an RGB (red/green/blue) setpoint of 104 was used (RGB=104 generally corresponds to a shade of brown generally associated with a browned, crisped food item). A tolerance of 100 was used. Additionally, a Kraft DiGiorno pizza was used. The number of pixels having that shade was recorded, such that a greater number of pixels indicated that more browning was present.

It will be noted that prior to evaluating structure 5-1 (control), the unheated pizza crust was examined to determine a baseline pixel count of 24313 pixels having the color associated with the RGB value 104. This baseline value was used to calculate the results presented in Table 1, where:
ΔUB is the number of pixels for a given sample minus the baseline value for an unbrowned crust (24313); and
Δ% Imp is the percent improvement over the results obtained by the control sample (structure 5-1).

The calorimetry results and pizza browning results both show significant increases over control for all the unoriented, low crystallinity films, whether they incorporated additives or not. Visual observations of the cooked pizza crusts confirmed much more desirable levels of browning than were achieved with the standard control sample made from highly biaxially oriented, high crystallinity film. Thus, strengthening additives can improve film robustness with no detriment to performance when incorporated into microwave susceptor films and structures.

TABLE 5

| | | | | | | Crystallization | | Melting | |
|---|---|---|---|---|---|---|---|---|---|
| | | | Wt | | | exotherm | | endotherm | |
| Sample/ | | Thickness | (lb/ | | Tg | Peak | ΔH | Peak | ΔH |
| Structure | Film | (microns) | ream) | Additive | (° C.) | T (° C.) | (J/g) | T (° C.) | (J/g) |
| 5-1 | BOPET | 12 | 10.4 | None | 75 | None | None | 252 | 41 |
| 5-2 | Nylon 6, 6 | 25 | 17.6 | None | — | — | — | 261 | 70 |
| 5-3 | APET | 13 | 11.2 | None | 74 | 135 | −37 | 247 | 37 |
| 5-4 | APET | 25 | 22.4 | None | 78 | 141 | −36 | 250 | 36 |
| 5-5 | APET | 12 | 10.4 | None | 77 | 130, 136 | −36 | 251 | 36 |
| 5-6 | APET | 20 | 17.0 | 3% Optema TC120 | 78 | 129 | −28 | 251 | 34 |
| 5-7 | APET | 20 | 18.9 | 5% Optema TC120 | 63, 79 | 129 | −28 | 251 | 36 |
| 5-8 | APET | 20 | 14.0 | 3% Optema TC220 | 63, 79 | 130 | −32 | 251 | 33 |
| 5-9 | APET | 20 | 16.7 | 5% Optema TC220 | — | — | — | — | — |
| 5-10 | APET | 20 | 19.2 | 3% Engage 8401 | 62, 79 | 131 | −28 | 252 | 36 |
| 5-11 | APET | 20 | 17.8 | 5% Engage 8401 | — | — | — | — | — |
| 5-12 | APET | 20 | 16.2 | 3% Sukano F35 | 60, 78 | 127 | −26 | 252 | 35 |
| 5-13 | APET | 20 | 15.7 | 5% Sukano F35 | — | — | — | — | — |
| 5-14 | APET | 20 | 17.8 | 3% Americhem | 64, 80 | 134 | −28 | 252 | 34 |
| 5-15 | APET | 20 | 15.9 | 5% Americhem | — | — | — | — | — |

| | Peak load | | | | | | |
|---|---|---|---|---|---|---|---|
| Sample/ | MD/CD | | PEL | ΔΔT | | | % Δ |
| Structure | (lbf/in) | Haze | 120 | (° C.) | Pixels | ΔUB | Imp |
| 5-1 | 3.97 | 3.6 | 16.9 | n/a | 43577 | 19264 | n/a |
| | 4.19 | | | | | | |
| 5-2 | 9.5 | <8.0 | — | 16.2 | 60798 | 36485 | 89.4 |
| | 9.0 | | | | | | |
| 5-3 | — | — | — | — | — | — | — |
| 5-4 | 3.97 | 2.0 | 9.0 | 24.8 | 56248 | 31935 | 65.8 |
| | 4.19 | | | | | | |
| 5-5 | — | — | — | — | — | — | — |
| 5-6 | 5.61 | 13.1 | 17.5 | 16.7 | 56958 | 32645 | 69.5 |
| | 5.45 | | | | | | |
| 5-7 | 6.30 | 15.0 | 11.9 | 20.3 | 69477 | 45164 | 134.4 |
| | 5.77 | | | | | | |
| 5-8 | 5.56 | 6.7 | 18.0 | 16.7 | 65890 | 41577 | 115.8 |
| | 5.06 | | | | | | |
| 5-9 | 5.39 | 14.8 | 13.5 | 25.8 | 62745 | 38432 | 99.5 |
| | 4.74 | | | | | | |
| 5-10 | 5.96 | 11.2 | 20.5 | 17.9 | 78926 | 54613 | 183.5 |
| | 5.34 | | | | | | |
| 5-11 | 5.83 | 21.7 | 3.6 | 29.3 | 66470 | 42157 | 118.8 |
| | 4.73 | | | | | | |
| 5-12 | 5.24 | 7.7 | 10.1 | 35.8 | 79637 | 55324 | 187.2 |
| | 4.79 | | | | | | |
| 5-13 | 5.27 | 10.9 | 8.6 | 30.4 | 62952 | 38639 | 100.6 |
| | 4.21 | | | | | | |
| 5-14 | 5.41 | 7.3 | 3.7 | 26.8 | 85485 | 61172 | 217.5 |
| | 5.16 | | | | | | |
| 5-15 | 5.16 | 12.8 | 6.0 | 21.8 | 75940 | 51627 | 168.0 |
| | 4.48 | | | | | | |

While the present invention is described herein in detail in relation to specific aspects and embodiments, it is to be understood that this detailed description is only illustrative and exemplary of the present invention and is made merely for purposes of providing a full and enabling disclosure of the present invention and to set forth the best mode of practicing the invention known to the inventors at the time the invention was made. The detailed description set forth herein is illustrative only and is not intended, nor is to be construed, to limit the present invention or otherwise to exclude any such other embodiments, adaptations, variations, modifications, and equivalent arrangements of the present invention. All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other. Further, various elements discussed with reference to the various embodiments may be interchanged to create entirely new embodiments coming within the scope of the present invention.

What is claimed is:

1. A microwave energy interactive structure, comprising:
a polymer film having a crystallinity of less than about 50%; and
a layer of microwave energy interactive material on the polymer film, the layer of microwave energy interactive material being operative for converting at least a portion of impinging microwave energy into thermal energy.

2. The microwave energy interactive structure of claim 1, wherein the polymer film has a crystallinity of less than about 25%.

3. The microwave energy interactive structure of claim 1, wherein the polymer film has a crystallinity of less than about 10%.

4. The microwave energy interactive structure of claim 1, wherein the polymer film has a crystallinity of less than about 7%.

5. The microwave energy interactive structure of claim 1, wherein the polymer film has a crystallinity of about 5%.

6. The microwave energy interactive structure of claim 1, wherein the polymer film comprises amorphous polyethylene terephthalate.

7. The microwave energy interactive structure of claim 1, wherein the polymer film comprises amorphous nylon.

8. The microwave energy interactive structure of claim 1, wherein the polymer film is unoriented.

9. The microwave energy interactive structure of claim 1, wherein the polymer film is substantially unoriented.

10. The microwave energy interactive structure of claim 1, further comprising an additive for enhancing the strength of the polymer film.

11. The microwave energy interactive structure of claim 10, wherein the additive is present in an amount up to about 10% by weight of the polymer film.

12. The microwave energy interactive structure of claim 10, wherein the additive is present in an amount up to about 5% by weight of the polymer film.

13. The microwave energy interactive structure of claim 10, wherein the additive comprises an ethylene methyl acrylate copolymer.

14. The microwave energy interactive structure of claim 10, wherein the additive comprises an ethylene-octene copolymer.

15. The microwave energy interactive structure of claim 1, wherein the polymer film is a multilayer polymer film.

16. The microwave energy interactive structure of claim 15, wherein the multilayer film includes
a layer comprising amorphous polyethylene terephthalate, and
at least one of a layer of amorphous nylon, a layer of amorphous nylon 6,6, a layer of olefin, and a layer of ethylene vinyl alcohol.

17. The microwave energy interactive structure of claim 15, wherein the multilayer film includes
a layer comprising at least one of amorphous nylon and nylon 6,6, and
at least one of a layer of amorphous polyethylene terephthalate, a layer of olefin, and a layer of ethylene vinyl alcohol.

18. The microwave energy interactive structure of claim 1, further comprising a support layer joined to the layer of microwave energy interactive material such that the layer of microwave energy interactive material is disposed between the polymer film and the support layer.

19. The microwave energy interactive structure of claim 18, wherein the support layer comprises paper, paperboard, or any combination thereof.

20. The microwave energy interactive structure of claim 1, comprising at least a portion of a microwave heating construct for heating, browning, and/or crisping a food item in a microwave oven.
